(19) United States
(12) Patent Application Publication
(10) Pub. No.: US 2025/0222813 A1
(43) Pub. Date: Jul. 10, 2025

(54) VEHICLE CHARGING SYSTEM

(71) Applicant: TOYOTA JIDOSHA KABUSHIKI KAISHA, Toyota-shi (JP)

(72) Inventor: Kazuhisa MATSUDA, Ebina-shi (JP)

(73) Assignee: TOYOTA JIDOSHA KABUSHIKI KAISHA, Toyota-shi (JP)

(21) Appl. No.: 18/904,831

(22) Filed: Oct. 2, 2024

(30) Foreign Application Priority Data
Jan. 4, 2024 (JP) 2024-000073

(51) Int. Cl. B60L 53/66; B60L 53/62

(52) U.S. Cl. CPC B60L 53/66; B60L 53/62

(57) ABSTRACT

The input device receives an input operation regarding the scheduled departure time. The setting unit sets a charging target SOC. The charging control unit controls charging of the power storage device so that SOC thereof becomes the charging target SOC by the scheduled departure time. The storage device stores information on the result of the departure time of the vehicle and information on the setting history of the charging target SOC in association with each other. The setting unit statistically processes the information stored in the storage device to obtain a reference time, which is an estimated value of the departure time, and a reference SOC, which is an estimated value of the charging target SOC. The setting unit sets the charging target SOC by changing the reference SOC in accordance with a time difference between the scheduled departure time and the reference time received by the input device.

### CROSS-REFERENCE TO RELATED APPLICATION

This application claims priority to Japanese Patent Application No. 2024-000073 filed on Jan. 4, 2024, incorporated herein by reference in its entirety.

### BACKGROUND

### 1. Technical Field

The present disclosure relates to a charging system for a vehicle including a power storage device.

### 2. Description of Related Art

Japanese Unexamined Patent Application Publication No. 2022-146415 (JP 2022-146415 A) discloses a charging control device that charges a battery mounted on a vehicle with electric power supplied from an external power supply. The charging control device determines, based on history information indicating a usage state and a charging state of the battery, a pattern of a charging cycle that is most similar to a charging habit of a user among a plurality of patterns of the charging cycle. The charging control device causes a display unit to display a charging completion state of charge (SOC), the charging start SOC, and an allowable lower limit SOC in the determined pattern of the charging cycle. When the setting is changed so that the charging completion SOC decreases in response to user's manipulation, the charging control device controls the battery to be charged based on the charging completion SOC that has been changed in the setting.

### SUMMARY

Charging actions of the user include timer charging in which a next scheduled departure time of the vehicle is set and charging of the battery is completed by the scheduled departure time. In the charging control device, the charging completion SOC in the timer charging is displayed in accordance with the pattern of the charging cycle determined from the charging habit of the timer charging of the user.

In a case where the user wants to perform timer charging different from that of the charging habit, for example, in a case where the next scheduled departure time of the vehicle is different from the normal departure time, the charging plan for the timer charging cannot be changed. Further, there is a possibility that the usage state of the battery changes along with the change of the scheduled departure time of the vehicle, but the charging completion SOC cannot be set to cope with the change of the usage state of the battery.

The user may set the charging completion SOC each time together with the scheduled departure time of the vehicle, but this increases the time and effort of the user. In some cases, it is not easy for the user to set an appropriate charging completion SOC in consideration of the usage state of the battery. As a result, there is concern that usability at the time of setting the timer charging decreases.

The present disclosure has been made to solve the above problems, and an object of the present disclosure is to improve usability at the time of setting timer charging of a vehicle including a power storage device.

A vehicle charging system according to an aspect of the present disclosure includes:
a vehicle including a power storage device;
power supply equipment configured to charge the power storage device from an outside of the vehicle; and
an input device, a setting unit, a charging control unit, and a storage device.

The input device is configured to receive an input operation for a scheduled departure time of the vehicle from a user of the vehicle.

The setting unit is configured to set a charging target state of charge indicating a charging target of a state of charge of the power storage device based on the scheduled departure time received by the input device.

The charging control unit is configured to control charging of the power storage device by the power supply equipment to cause the state of charge of the power storage device to reach the charging target state of charge before the scheduled departure time.

The storage device is configured to store information on a record of a departure time of the vehicle and information on a setting history of the charging target state of charge in association with each other.

The setting unit is configured to acquire, by statistically processing the pieces of information stored in the storage device, a reference time that is an expected value of the departure time and a reference state of charge that is an expected value of the charging target state of charge. The setting unit is configured to set the charging target state of charge by changing the reference state of charge in accordance with a time difference between the scheduled departure time received by the input device and the reference time.

In the above configuration, the charging target state of charge in the timer charging is automatically set in accordance with the user input for the next scheduled departure time of the vehicle. Therefore, the user need not input the charging target state of charge. Thus, the time and effort of the user are reduced. Further, the charging target state of charge is set based on the scheduled departure time using the reference time and the reference state of charge derived from the pieces of information on the usage record of the vehicle and the setting history of the charging target state of charge. Therefore, the charging target state of charge can appropriately be set in consideration of the usage state of the power storage device in the next travel. Thus, the usability at the time of setting the timer charging can be improved.

The setting unit may be configured to set the charging target state of charge to the reference state of charge when the time difference between the scheduled departure time and the reference time is equal to or smaller than a predetermined threshold.

When the scheduled departure time coincides with the reference time, determination is made that the charging target state of charge also coincides with the reference state of charge. Therefore, the charging target state of charge can automatically be set to an appropriate value reflecting the usage habit of the vehicle and the execution habit of the timer charging for the user.

When the time difference between the scheduled departure time and the reference time is larger than the threshold, the setting unit may (1) set the charging target state of charge to a value higher than the reference state of charge when the scheduled departure time is earlier than the reference time.

When the time difference between the scheduled departure time and the reference time is larger than the threshold, the setting unit may (2) set the charging target state of charge to a value lower than the reference state of charge when the scheduled departure time is later than the reference time.

With this configuration, the charging target state of charge can be set to an appropriate value in consideration of the usage state of the power storage device even when the scheduled departure time deviates from the reference time.

The setting unit may be configured to acquire the reference time by statistically processing information on a record of the departure time on the same day of week as a day of week of the scheduled departure time.

Thus, it is possible to acquire the reference time based on the usage habit of the vehicle for the user.

The setting unit may be configured to acquire the reference state of charge by statistically processing information on a setting history of the charging target state of charge on the same day of week as a day of week of the scheduled departure time or in the same time frame as a time frame of the scheduled departure time.

Thus, it is possible to acquire the reference state of charge based on the execution habit of the timer charging for the user.

The vehicle charging system may further include a notification device configured to notify the user about the charging target state of charge set by the setting unit. The input device may be configured to receive a user input for changing the charging target state of charge.

The setting unit may be configured to change setting of the charging target state of charge in response to the user input.

With this configuration, the user can appropriately change the charging target state of charge in accordance with the next travel plan of the vehicle.

According to the present disclosure, it is possible to improve the usability at the time of setting the timer charging of the vehicle including the power storage device.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a configuration example of a vehicle to which a charging system according to an embodiment is applied;

FIG. 2 is a diagram illustrating a schematic configuration of a charging system of a vehicle according to an embodiment;

FIG. 3 is a diagram illustrating an example of a setting screen of a charging plan displayed on a touch panel display of a user terminal;

FIG. 4 is a flow chart illustrating an exemplary process of setting a charging target SOC in timer charging;

FIG. 5 is a diagram describing information stored in a storage device of server; and

FIG. 6 is a flow chart illustrating another exemplary process of setting a charging target SOC in timer charging.

### DETAILED DESCRIPTION OF EMBODIMENTS

Hereinafter, an embodiment of the present disclosure will be described in detail with reference to the drawings. In the drawings, the same or corresponding parts are denoted by the same reference numerals, and the description thereof will not be repeated.

### Configuration of the Vehicle

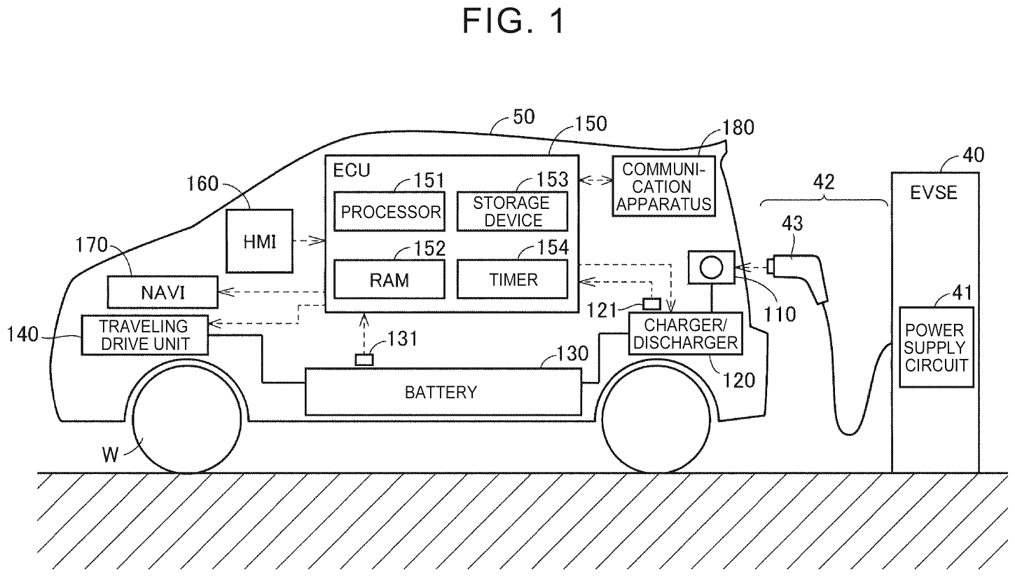

FIG. 1 is a diagram illustrating a configuration example of a vehicle to which a vehicle charging system according to the present embodiment is applied. As illustrated in FIG. 1, the vehicle 50 includes a battery 130 that stores traveling electric power, an inlet 110, a charger/discharger 120, a monitoring module 121, 131, a traveling drive unit 140, an Electronic Control Unit (ECU) 150, a Human Machine Interface (HMI) 160, a navigational system (hereinafter, also referred to as “NAVI”) 170, and a communication apparatus 180.

The battery 130 is, for example, a secondary battery such as a lithium-ion battery or a nickel metal hydride battery, or an electric double layer capacitor. The battery 130 corresponds to an embodiment of a “power storage device”. The vehicles 50 may be battery electric vehicle that can travel using only the electric power stored in the battery 130. Vehicle 50 may be a plug-in hybrid electric vehicle that can travel using both the power stored in battery 130 and the power output of the engine.

The monitoring module 131 monitors the state of the battery 130. The monitoring module 131 includes various sensors for detecting the status (e.g., voltage, current, and temperature) of the battery 130, and outputs the detection result to ECU 150. ECU 150 may obtain the status (e.g., voltage, current, temperature, State Of Charge (SOC) and internal resistance of the battery 130 based on the output of the monitoring module 131.

Electric Vehicle Supply System (EVSE) Reference numeral 40 denotes power supply equipment for a vehicle. EVSE 40 includes power supply circuitry 41. A charging cable 42 is connected to EVSE 40. The charging cable 42 has a connector 43 at its distal end and a power line therein.

The inlet 110 is configured to be connectable to the connector 43 of the charging cable 42. When the connector 43 of the charging cable 42 is connected to the inlet 110, the vehicle 50 and EVSE 40 are electrically connected, and power can be supplied from EVSE 40 to the vehicle 50 through the charging cable 42. Thus, the vehicle 50 can perform external charging (that is, charging of the battery 130 by electric power from the outside of the vehicle).

The charger/discharger 120 is disposed between the inlet 110 and the battery 130. The charger/discharger 120 includes a relay for switching connection/disconnection of a power path from the inlet 110 to the battery 130, and a power converter (for example, a bidirectional converter). The power converter converts the electric power received by the inlet 110 into electric power suitable for charging the battery 130 (that is, electric power for external charging), and outputs the electric power to the battery 130. The relays and power converters are controlled by ECU 150.

The monitoring module 121 monitors the state of the charger/discharger 120. The monitoring module 121 includes various sensors for detecting the status of the charger/discharger 120 (e.g., a voltage and a current input and output to/from the power converter), and outputs the detection result to ECU 150.

The traveling drive unit 140 includes Power Control Unit (PCU) and Motor Generator (MG), and uses the electric power stored in the battery 130 to drive the vehicle 50. PCU includes a power converter, a System Main Relay (SMR), and a controller. The controller controls the power converters and relays in accordance with instructions from ECU 150. MG is, for example, a three-phase AC motor generator, and is driven by a PCU to rotate the drive wheels W. MG supplies the regenerated electric power to the battery 130. SMR switches the connection/disconnection of the power path from the battery 130 to PCU.

ECU 150 includes a processor 151, a Random Access Memory (RAM) 152, a storage device 153, and a timer 154. For example, Central Processing Unit (CPU) is adopted as the processor 151. RAM 152 functions as working memories for temporarily storing data to be processed by the processor 151. The timer 154 is configured to inform the processor 151 of the arrival of the set time.

The storage device 153 includes, for example, Read Only Memory (ROM) and non-volatile memories. The storage device 153 stores information used in the program in addition to the program. The processor 151 executes programs stored in the storage device 153 to perform various types of control by ECU 150. The various types of control are not limited to the execution by software, and may be executed by dedicated hardware.

The information stored in the storage device 153 includes information related to the use history of the vehicle 50, information related to the execution history of the external charging, and information related to the use plan of the vehicle 50. The usage history of the vehicle 50 includes a travel history of the vehicle 50 (for example, a departure time of the vehicle 50, a travel route, and a travel time). The execution history of the external charging includes the charging location, the specification of the power supply equipment installed in the charging location, and the execution history of the timer charging. The timer charging is to perform external charging so that SOC of the battery 130 becomes the charging target SOC by the scheduled departure time of the vehicle 50. In order to avoid a situation in which SOC of the battery 130 is decreasing at the time of departure of the vehicle 50, the charging of the battery 130 is controlled by the processor 151 so that SOC reaches the charging target SOC at the scheduled departure time. The execution history of the timer charging includes the setting history of the charging target SOC.

The usage plan of the vehicle 50 includes a travel plan of the vehicle 50 (for example, a scheduled departure time and a travel route of the vehicle 50) and a charge plan of the battery 130 (for example, a charging target SOC).

HMI 160 includes an inputting device and a displaying device. HMI 160 may include a touch panel display. HMI 160 may include a meter panel and/or a head-up display. HMI 160 may include a smart speaker that accepts audio input. The user can register the above-described usage plan of the vehicle 50 in the storage device 153 using HMI 160. HMI 160 corresponds to one embodiment of the “inputting device” and the “notification device”.

NAVI 170 includes a touch panel display, a Global Positioning System (GPS) module, a processor, and a storage device. The storage device stores map information. The touch panel display receives an input from a user and displays a map and other information. NAVI 170 receives signals from GPS satellites and uses the received signals to detect the position of the vehicle 50. NAVI 170 searches for an optimum route from the present position of the vehicle 50 to the destination by referring to the map information. NAVI 170 corresponds to one embodiment of the “inputting device” and the “notification device”.

The communication apparatus 180 includes various communication I/F. ECU 150 communicates with a communication device outside the vehicle 50 through the communication apparatus 180. The communication devices outside the vehicle 50 include EVSE 40, server 30 and user terminals 80, which will be described later. ECU 150 transmits information (information on the use history of the vehicle 50, information on the execution history of the external charge, and information on the use plan of the vehicle 50) stored in the storage device 153 to the server 30 through the communication apparatus 180.

### Configuration of Vehicle Charging System

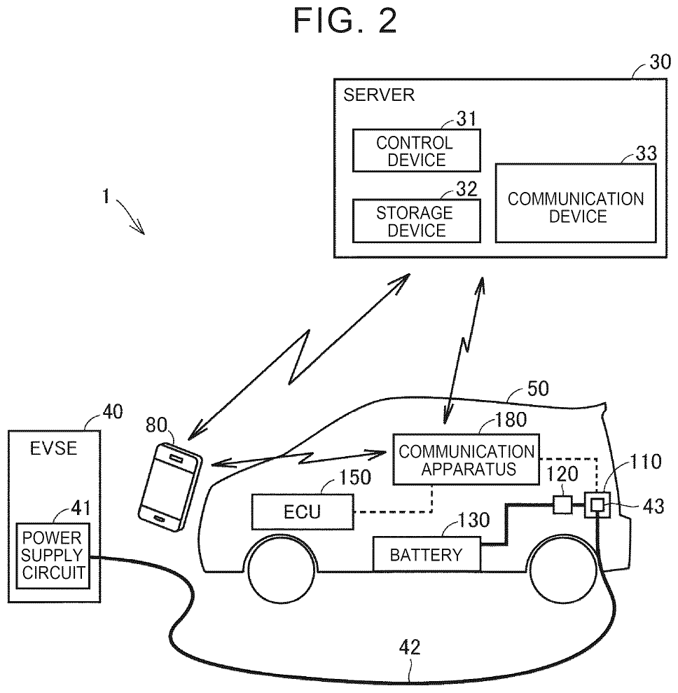

FIG. 2 is a diagram illustrating a schematic configuration of a charging system of a vehicle according to the present embodiment. As illustrated in FIG. 2, the vehicle charging system 1 includes a server 30, a EVSE 40, a vehicle 50, and a user terminal 80.

The user terminal 80 corresponds to an embodiment of a “terminal device” carried by a user of the vehicle 50. In the example of FIG. 2, the user terminal 80 is a smartphone, but any terminal device can be adopted. A predetermined application software (hereinafter, simply referred to as “application”) is installed in the user terminal 80. The user terminal 80 can exchange various kinds of information with the server 30 and the communication apparatus 180 mounted on the vehicle 50 through the application. The user can operate the application through, for example, a touch panel display of the user terminal 80. In addition, the touch panel display of the user terminal 80 can notify the user of information.

The server 30 is configured to be able to communicate with each of the vehicle 50 and the user terminal 80. The server 30 includes a control device 31, a storage device 32, and a communication device 33. The control device 31 includes a processor and performs predetermined information processing and controls the communication device 33.

The storage device 32 stores a program executed by the control device 31 and various kinds of information used in the program. The various kinds of information include information received from ECU 150 of the vehicle 50 (information on the use history of the vehicle 50, information on the execution history of the external charge, and information on the use plan of the vehicle 50).

The communication device 33 includes various communication I/F. The control device 31 communicates with the user terminal 80 and the communication apparatus 180 of the vehicle 50 through the communication device 33, and receives information. The server 30 updates the information in the storage device 32 based on the received information.

### Battery Timer Charging

Next, timer charging of the battery 130 will be described. In the present embodiment, the user can set a charging schedule related to the timer charging of the battery 130 by operating the user terminal 80, HMI 160, or NAVI 170. Hereinafter, an example in which the user operates the user terminal 80 to set a charging plan will be described.

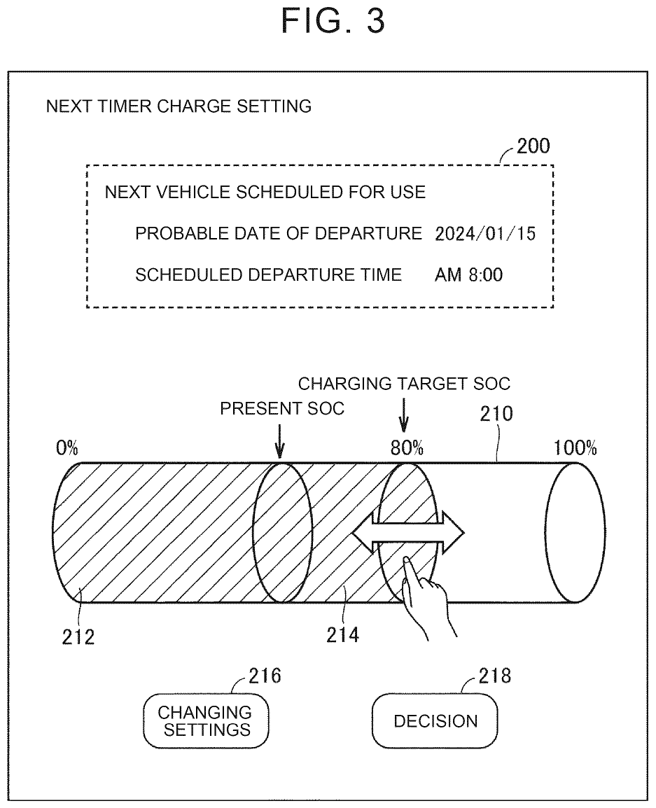

FIG. 3 is a diagram illustrating an example of a charging plan setting screen displayed on a touch panel display of the user terminal 80. As illustrated in FIG. 3, the setting screen includes an operation unit 200, a setting bar 210, a display bar 212,214, and a button 216,218.

The operation unit 200 receives a user input regarding the next use schedule of the vehicle 50. The next scheduled use of the vehicle 50 includes a scheduled departure date and a scheduled departure time of the next vehicle 50. The user can set the scheduled departure date and the scheduled departure time of the next vehicle 50 by operating the operation unit 200.

The display bar 212 is displayed on the setting bar 210 and displays the present SOC of the battery 130 in the length of the bar. The display bar 214 is displayed on the setting bar 210, and displays the setting value of the charging target SOC in the next timer charging by the length of the bar.

In the present embodiment, the charging target SOC is automatically set on the basis of the next scheduled use (scheduled departure date and scheduled departure time) of the vehicle 50 received by the operation unit 200, and a display bar 214 indicating the setting value of the charging target SOC is displayed on the setting bar 210. According to this configuration, it is possible to save time and effort for the user to enter the charging target SOC. The setting of the charging target SOC will be described in detail later.

The button 216 is a button for enabling the user to change the setting of the charging target SOC displayed on the setting bar 210. The user can change the charging target SOC by performing an operation of touching the button 216 and then touching the right end of the display bar 214 to slide in the left-right direction.

The button 218 is a button for completing setting of the use schedule and the charging target SOC of the vehicle 50. The user can confirm each setting by touching the button 218.

### Setting the Charging Target SOC

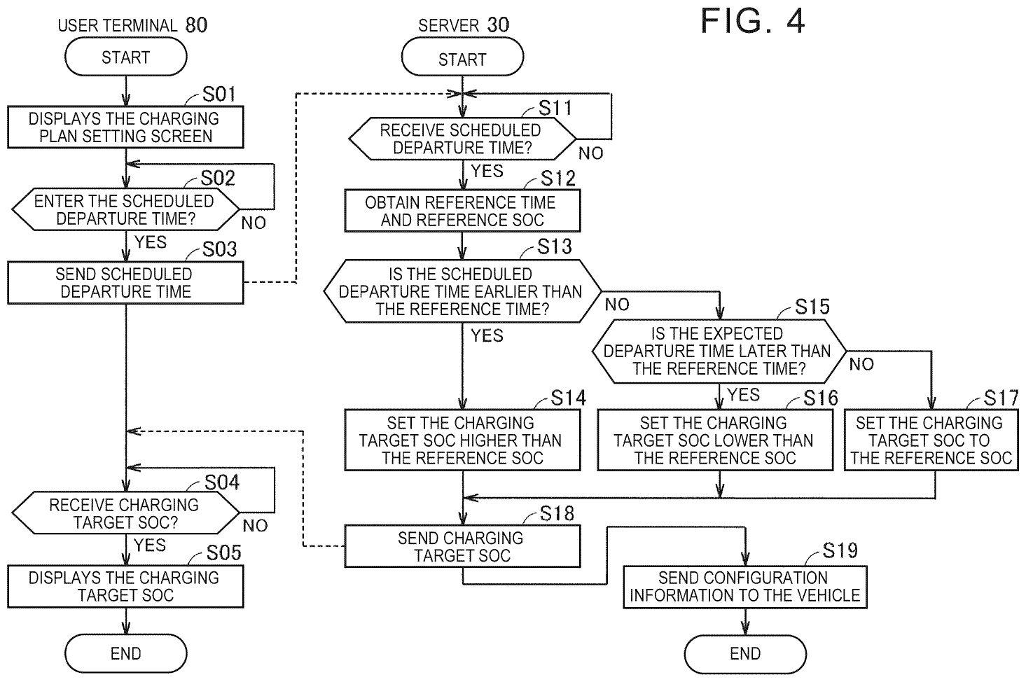

FIG. 4 is a flow chart illustrating an exemplary process of setting a charging target SOC in timer charging. The series of processes illustrated in the flowchart of FIG. 4 is executed by the user terminal 80 and the server 30 when the user sets a charging plan using the user terminal 80. The server 30 corresponds to an embodiment of the “setting unit”.

In the figure, the processing executed by the user terminal 80 is shown on the left, and the processing executed by the server 30 is shown on the right. Each step is realized by software processing by the processor in the user terminal 80 and the control device 31 of the server 30, but may be realized by electronic circuits (hardware) arranged in the user terminal 80 and the server 30.

In step (hereinafter simply referred to as “S”) 01, the user terminal 80 displays a charging plan setting screen (FIG. 3) on the touch panel display in response to receiving a charging plan setting request from the user. In one aspect, the user terminal 80 displays a charging plan setting screen (FIG. 3) in response to a user activation of a pre-installed application.

In S02, the user terminal 80 determines whether or not the user input regarding the next scheduled use of the vehicle 50 (scheduled departure date and scheduled departure time) has been received. When the user input regarding the next scheduled use of the vehicle 50 is received (at the time of YES determination of S02), the user terminal 80 transmits information regarding the next scheduled use of the vehicle 50 (scheduled departure date and scheduled departure time) to the server 30 by S03.

In S11, the server 30 determines whether or not information (a scheduled departure date and a scheduled departure time) related to the next scheduled use of the vehicle 50 has been received from the user terminal 80. When the information on the next scheduled use of the vehicle 50 (the scheduled departure date and the scheduled departure time) is received (at the time of YES determination of S11), the server 30 acquires the reference time and the reference SOC by S12 based on the information stored in the storage device 32. The reference time is an estimated value of the departure time of the vehicle 50. The reference SOC is an estimated charging target SOC in timer charge.

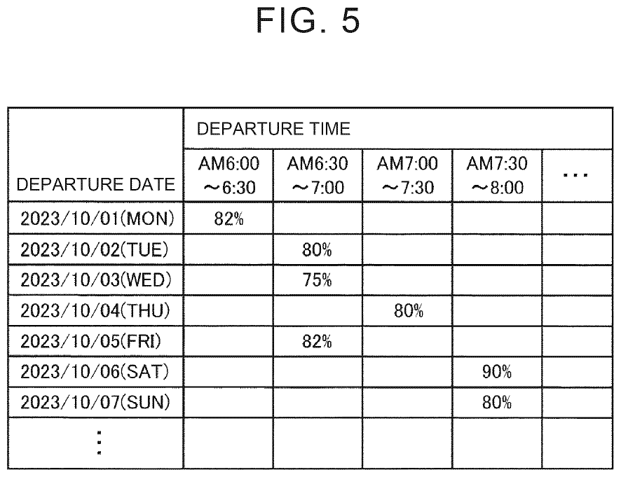

FIG. 5 is a diagram illustrating information stored in the storage device 32 of the server 30. The information stored in the storage device 32 includes information on the travel history of the vehicle 50 and the execution history of the timer charge received from ECU 150 of the vehicle 50. As illustrated in FIG. 5, the storage device 32 stores information on the result of the departure time of the vehicle 50 and information on the setting history of the charging target SOC in association with each other.

FIG. 5 shows a time zone including a result of the departure date and a result of the departure time of the vehicle 50. The length of each time zone can be set arbitrarily. FIG. 5 further shows the setting of the charging target SOC in the immediately preceding timer charge on each departure day. The period in which the travel history of the vehicle 50 and the execution history of the timer charging are stored in the storage device 32 can be set to an arbitrary length. In an aspect, the length of the period can be set in consideration of the fact that the usage mode of the vehicle 50 also changes in accordance with the change of the living environment of the user (the residence place, the climate, the work place, and the like).

The server 30 obtains the reference time by performing statistical processing on the information illustrated in FIG. 5. For example, the server 30 acquires the reference time by performing statistical processing on the actual result of the departure time on the same day of the week as the scheduled departure date of the next vehicle 50. The reference time may be, for example, a time zone including an average value or a mode value of an actual departure time of the same day of the week as the scheduled departure date.

In addition, the server 30 acquires the reference SOC by statistically processing the data illustrated in FIG. 5. In an aspect, the server 30 acquires the reference SOC by statistically processing the setting history of the charging target SOC on the same day of the week as the next scheduled departure date of the vehicle 50. The reference SOC may be, for example, a mean value or a mode value of the set values of the charging target SOC on the same day of the week.

In another aspect, the server 30 acquires the reference SOC by statistically processing the setting history of the charging target SOC in the same time zone as the next scheduled departure time of the vehicle 50. The reference SOC may be, for example, a mean value or a mode value of the set values of the charging target SOC in the same period.

Next, the server 30 compares the reference time acquired by S12 with the scheduled departure time of the next vehicle 50, and determines whether or not the scheduled departure time matches the reference time. For example, the server 30 obtains a time difference between the reference time and the scheduled departure time, and determines that the scheduled departure time coincides with the reference time when the magnitude of the time difference is equal to or less than a predetermined threshold. If the time difference is greater than the threshold, the server 30 further determines whether the scheduled departure time is earlier or later than the reference time.

When the scheduled departure time is earlier than the reference time (YES determination of S13), the server 30 sets the charging target SOC in the next timer charge to be higher than the reference SOC by S14. In S14, the server 30 assumes that the vehicle 50 has traveled for a time corresponding to a time difference between the reference time and the scheduled departure time, and calculates the electric power required for the traveling. The amount of electric power can be calculated, for example, by calculating the distance that the vehicle 50 can travel in the above-described time, and calculating the calculated distance from the travelable distance and the electric power cost of the vehicle 50. The distance travelable by the vehicle 50 can be calculated from the travel history of the vehicle 50 stored in the storage device 32 or the travel mode (vehicle speed) of the vehicle 50. The server 30 sets the charging target SOC by adding the calculated electric energy to the reference SOC.

On the other hand, when the scheduled departure time is later than the reference time (YES determination of S15), the server 30 sets the charging target SOC in the next timer charge to be lower than the reference SOC by S16. In S16, in contrast to S14, the server 30 assumes that the vehicle 50 is not traveling for a time corresponding to a time difference between the reference time and the scheduled departure time, and calculates the electric power required for the traveling. Then, the server 30 sets the charging target SOC by subtracting the calculated electric energy from the reference SOC.

When the scheduled departure time coincides with the reference time (NO determination of S15), the server 30 sets the charging target SOC in the next timer charge to the reference SOC by S17.

When the charging target SOC is set by either S14, S16 or S17, the server 30 transmits the set charging target SOC to the user terminal 80 by S18. Further, the server 30 transmits the setting of the charging target SOC to ECU 150 of the vehicle 50 in association with the next scheduled departure date and scheduled departure time of the vehicle 50 by S19. Accordingly, ECU 150 of the vehicle 50 controls the charging of the battery 130 so that SOC of the battery 130 becomes the charging target SOC by the scheduled departure time on the next scheduled departure date. ECU 150 corresponds to an embodiment of a “charging control unit”.

The user terminal 80 transmits information (a scheduled departure date and a scheduled departure time) related to the next scheduled use of the vehicle 50 to the server 30 in S03, and then determines whether or not the setting of the charging target SOC has been received from the server 30 by S04. When the setting value of the charging target SOC is received (at the time of S04's YES determination), the user terminal 80 displays a display bar 214 indicating the setting value of the charging target SOC on the setting bar 210 of the charging planning setting window (FIG. 3) by S05.

As described above, according to the vehicle charging system of the present embodiment, the charging target SOC in the next timer charging is automatically set in accordance with the user input regarding the scheduled use (departure date and scheduled departure time) of the next vehicle. This eliminates the need for the user to enter the charging target SOC, thereby reducing the time and effort of the user. Further, the charging target SOC is set based on the scheduled departure time by using the reference time and the reference SOC derived from the information on the running history of the vehicle and the running history of the timer charging. Therefore, the charging target SOC can be appropriately set in anticipation of the usage state of the battery 130 due to the next travel while reflecting the usage habit of the vehicle and the usage habit of the timer charging by the user. Therefore, usability when setting timer charging can be improved.

### OTHER EMBODIMENTS

(1) In the above-described embodiment, a configuration has been described in which the charging target SOC in the timer charging is automatically set in accordance with the scheduled use (scheduled departure date and scheduled departure time) of the vehicle 50 next time and is displayed on the charging plan setting window (FIG. 3) of the user terminal 80. However, the user can appropriately change the set charging target SOC by touching the button 216 on the charging plan setting screen.

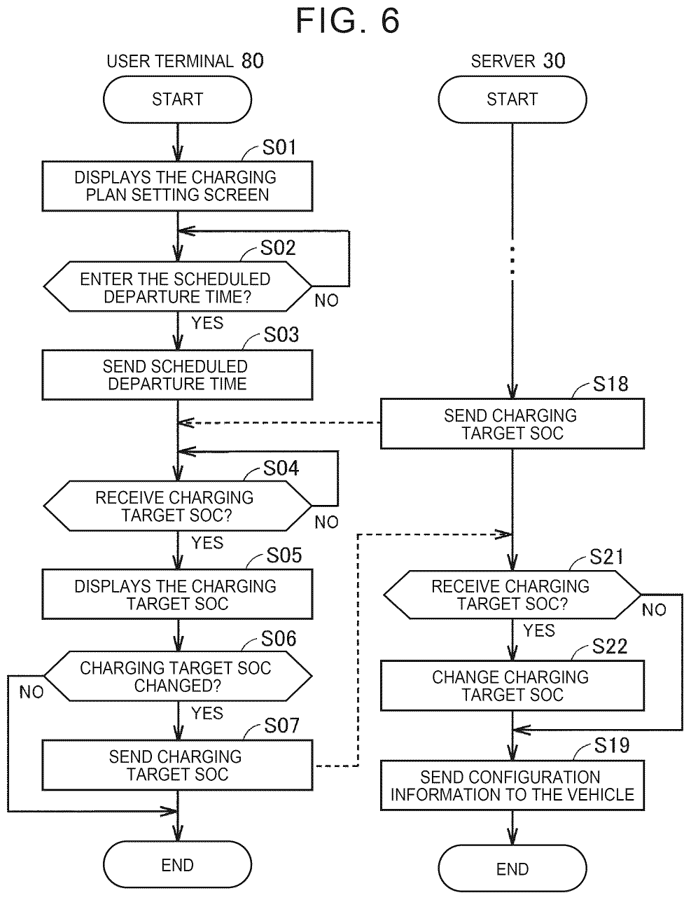

FIG. 6 is a flow chart illustrating another exemplary process of setting a charging target SOC in timer charging. The flow chart shown in FIG. 6 is a flow chart shown in FIG. 4 in which S06, S07, S20 and S21 processes are added. Note that since S17 from S1 of the processes executed by the server 30 are the same as those in FIG. 4, the description thereof is omitted.

When the charging target SOC is displayed on the charging plan setting window (FIG. 3) by S05, the user terminal 80 determines whether or not a user manipulation for changing the charging target SOC has been received by S06. When a user operation for changing the charging target SOC is received (at the time of S06's YES determination), the user terminal 80 transmits the changed charging target SOC to the server 30 by S07.

After transmitting the charging target SOC to the user terminal 80 by S18, the server 30 determines whether or not the setting of the charging target SOC has been received from the user terminal 80 by S20. When the setting value of the charging target SOC is received from the user terminal 80 (at the time of S20's YES determination), the server 30 changes the charging target SOC to the received charging target SOC by S21 by either S14, S16 or S17. Then, the server 30 transmits the setting value of the charging target SOC to ECU 150 of the vehicle 50 in association with the next scheduled departure date and scheduled departure time of the vehicle 50 by S19.

When the charging target SOC is changed in response to the user's manipulation, the data (see FIG. 5) stored in the storage device 32 of the server 30 is updated. This makes it possible to reflect the change of the current charging target SOC in the setting of the charging target SOC in the next and subsequent timer charging.
(2) In the above-described embodiment, a configuration has been described in which the server 30 sets the charging target SOC in response to a user operation on the user terminal 80, but a configuration may be adopted in which ECU 150 of the vehicle 50 or the user terminal 80 sets the charging target SOC. In this instance, ECU 150 or the user terminal 80 functions as a “setting unit”.

It should be considered that the embodiments disclosed above are for illustrative purposes only and are not limitative of the disclosure in any aspect. It is intended that the scope of the disclosure be defined by the appended claims rather than the description of the embodiments described above, and that all changes within the meaning and range of equivalency of the claims be embraced therein.

What is claimed is:

1. A vehicle charging system comprising:
a vehicle including a power storage device;
power supply equipment configured to charge the power storage device from an outside of the vehicle;
an input device configured to receive an input operation for a scheduled departure time of the vehicle from a user of the vehicle;
a setting unit configured to set a charging target state of charge indicating a charging target of a state of charge of the power storage device based on the scheduled departure time received by the input device;
a charging control unit configured to control charging of the power storage device by the power supply equipment to cause the state of charge of the power storage device to reach the charging target state of charge before the scheduled departure time; and
a storage device configured to store information on a record of a departure time of the vehicle and information on a setting history of the charging target state of charge in association with each other, wherein the setting unit is configured to:
acquire, by statistically processing the pieces of information stored in the storage device, a reference time that is an expected value of the departure time and a reference state of charge that is an expected value of the charging target state of charge; and
set the charging target state of charge by changing the reference state of charge in accordance with a time difference between the scheduled departure time received by the input device and the reference time.

2. The vehicle charging system according to claim 1, wherein the setting unit is configured to set the charging target state of charge to the reference state of charge when the time difference between the scheduled departure time and the reference time is equal to or smaller than a predetermined threshold.

3. The vehicle charging system according to claim 2, wherein the setting unit is configured to, when the time difference between the scheduled departure time and the reference time is larger than the threshold:
set the charging target state of charge to a value higher than the reference state of charge when the scheduled departure time is earlier than the reference time; and
set the charging target state of charge to a value lower than the reference state of charge when the scheduled departure time is later than the reference time.

4. The vehicle charging system according to claim 1, wherein the setting unit is configured to acquire the reference time by statistically processing information on a record of the departure time on the same day of week as a day of week of the scheduled departure time.

5. The vehicle charging system according to claim 1, wherein the setting unit is configured to acquire the reference state of charge by statistically processing information on a setting history of the charging target state of charge on the same day of week as a day of week of the scheduled departure time or in the same time frame as a time frame of the scheduled departure time.

6. The vehicle charging system according to claim 1, further comprising a notification device configured to notify the user about the charging target state of charge set by the setting unit, wherein:
the input device is configured to receive a user input for changing the charging target state of charge; and
the setting unit is configured to change setting of the charging target state of charge in response to the user input.
